(19) United States
(12) Patent Application Publication
(10) Pub. No.: US 2020/0276916 A1
(43) Pub. Date: Sep. 3, 2020

(54) SEAT ADJUSTER HAVING CHARACTERISTIC-MAP CONTROL AND METHOD FOR SEAT ADJUSTMENT

(71) Applicant: Brose Fahrzeugteile SE & Co. Kommanditgesellschaft, Coburg, Coburg (DE)

(72) Inventors: Sandra KIESER, Coburg (DE); Gregor KRÖNER, Bischberg (DE); Jörg GROPP, Böhlen (DE); Christian KARL, Coburg (DE)

(73) Assignee: Brose Fahrzeugteile SE & Co. Kommanditgesellschaft, Coburg, Coburg (DE)

(21) Appl. No.: 16/645,034

(22) PCT Filed: Sep. 4, 2018
(86) PCT No.: PCT/EP2018/073667

§ 371 Date: Mar. 6, 2020

(30) Foreign Application Priority Data
Sep. 8, 2017 (DE) 10 2017 215 908.1

(51) Int. Cl. B60N 2/02; B60N 2/14; B60N 2/90; B60R 16/037

(52) U.S. Cl. CPC B60N 2/0228; B60N 2/143; B60N 2002/022; B60R 16/037; B60N 2/933

(57) ABSTRACT

A seat adjuster, comprising an adjustable vehicle seat, that may be adjusted by an external force between an initial position and a target position in an interior of a vehicle, the adjustment of the vehicle seat from the initial position into the target position requiring at least pivoting of the vehicle seat about a pivot axis extending from a floor to a ceiling of the vehicle, and an electronic control device for controlling an adjustment drive to adjust the vehicle seat from the initial position into the target position. A characteristic-map memory coupled to the electronic control device is provided, in which characteristic-map memory characteristic-map data for adjustment movements to be carried out by the vehicle seat are stored. The electronic control device controls the adjustment drive by means of the characteristic-map data to adjust the vehicle seat from a current initial position into a certain target position.

The invention relates to a seat adjuster and to a method for adjusting a vehicle seat.

What is known already are vehicle seats which in the vehicle interior are pivotable about a pivot axis that extends along a spatial direction pointing from a vehicle floor of the vehicle to the ceiling of the vehicle. Thus, the pivot axis for example can be a vertically extending upright axis. The pivotable vehicle seat in principle can be pivoted with respect to a neutral position oriented in the direction of travel of the vehicle, for example in the case of a driver seat to the right in the direction of the passenger seat or to the left in the direction of a vehicle door (the latter for example to provide for an easier entry and exit). Such a pivotable vehicle seat for example is known in principle from JP 9-156404 A.

In particular with regard to motor vehicles driving autonomously in the future, different vehicle interior design concepts currently are taken into consideration. Frequently, it is also provided that a vehicle seat will be distinctly more pivotable than this is realized in vehicles known so far. For example, it is envisaged that a vehicle seat will be pivotable by more than 90°, in particular by up to 180° about a pivot axis. For reasons of comfort, pivoting of the vehicle seat here will be effected in a power-operated way by means of at least one motorized drive.

A corresponding greater pivotability of the vehicle seat within a vehicle interior however involves various difficulties. The space available for a pivotal movement in the vehicle interior is limited and moreover also varies in different vehicle types. Thus, it possibly is not easily possible that the vehicle seat is transferred from a starting position into a desired, pivoted target position, when it must be ensured at the same time that during the adjustment a seat user currently sitting on the vehicle seat does not abut against vehicle components present in the vehicle interior and the vehicle seat itself does not collide either with such vehicle components.

Against this background there is thus a need for a seat adjuster improved in this respect and for a method for seat adjustment which is improved in this respect.

The resulting object for the provision of an improved seat adjuster in particular is achieved with a seat adjuster according to claim 1.

Such a seat adjuster at least comprises
an adjustable vehicle seat which is adjustable in a power-operated way between at least one starting position and at least one target position in an interior space of a vehicle (vehicle interior), wherein the adjustment of the vehicle seat from the at least one starting position into the at least one target position at least can include pivoting of a vehicle seat about a pivot axis which extends along a spatial direction pointing from a vehicle floor of the vehicle to a ceiling of the vehicle, i.e. for example is vertically oriented, and
an electronic control device for controlling at least one adjustment drive by means of which the vehicle seat can be driven for a power-operated adjustment from the at least one starting position into the at least one target position.

Furthermore, there is provided a characteristic-map memory coupled with the electronic control device. This characteristic-map memory stores characteristic-map data for adjusting movements to be carried out by the vehicle seat. By means of the characteristic-map data the electronic control device controls the at least one adjustment drive in order to adjust the vehicle seat from a current starting position into a particular target position. Accordingly, the adjustment of the vehicle seat is based on a characteristic-map control. Such a characteristic-map control can take account of the situation in the vehicle interior space, and in particular the starting position of the vehicle seat, in order to specify the best possible adjustment path for the vehicle seat until the target position is reached.

In one design variant, characteristic-map data for adjusting movements to be carried out by the vehicle seat are stored in the characteristic-map memory coupled with the electronic control device in dependence on the at least one starting position and at least one vehicle-specific and/or user-specific restriction parameter. The electronic control device then is configured to control the at least one adjustment drive by means of the characteristic-map data in order to adjust the vehicle seat into the target position in dependence on the current starting position. Thus, via the characteristic-map data of the characteristic-map memory, the electronic control device in this design variant on the one hand takes account of the current starting position of the vehicle seat and on the other hand takes account of at least one restriction parameter which is specific for the vehicle, in particular for the vehicle interior in which the vehicle seat is disposed, and/or which is specified on the part of the user. The at least one restriction parameter thus represents at least one structural and/or functional constraint which limits the adjustability of the vehicle seat from the possible starting positions and hence in particular from the current starting position to the desired target position.

In one design variant, the characteristic-map data comprise for example at least one static vehicle-specific restriction parameter which cannot be changed for the vehicle. For example, the at least one static vehicle-specific restriction parameter is dependent on the dimensions of the interior space of the vehicle and/or on the position and location of immovable vehicle components present in the interior of the vehicle. A static vehicle-specific restriction parameter thus takes account of restrictions due to the installation space, which in particular result from the design of the interior of the vehicle.

In this connection it can be provided for example that the at least one static vehicle-specific restriction parameter is dependent on the position and location of a headliner, a B-pillar and/or a dashboard of the vehicle. What varies for example in dependence on the vehicle type is the design and position of a B-pillar which can represent a possible obstacle on pivoting of a vehicle seat, in particular when a backrest of such a vehicle seat is strongly inclined to the rear. Via the characteristic-map data of the characteristic-map memory it then is stored here for example that from a particular angle of inclination of the backrest of the vehicle seat to the rear, the vehicle seat cannot be pivoted beyond a particular pivot angle, e.g. 90°, as otherwise the backrest inclined to the rear would collide with the B-pillar of the vehicle. On the basis of the characteristic-map data, a corresponding information then for example can be output to the user and in particular to a seat user of the vehicle seat stating that the desired adjustment into the target position is not possible without changing the starting position.

In a possible embodiment, the characteristic-map data take account of the at least one static vehicle-specific restriction parameter in order to adjust seat components provided on the vehicle seat and thereby provide for an adjustability into the target position without a collision with an immovable vehicle component. In this connection it can be specified for example via the characteristic-map data to actuate a backrest adjuster of the vehicle seat in order to (temporarily) transfer the backrest of the vehicle seat into another adjustment position so that the vehicle seat can take the desired target position. In the target position the backrest adjuster then can, if possible, automatically adjust the backrest back into the adjustment position corresponding to the starting position of the vehicle seat.

Alternatively or in addition, the characteristic-map data can comprise at least one dynamic vehicle-specific restriction parameter which has at least two values. The value of the at least one dynamic vehicle-specific restriction parameter here for example can be dependent on an adjustment position of at least one adjustable component which does not belong to the vehicle seat. Thus, via the dynamic vehicle-specific restriction parameter basically variable constraints are taken into account, which can influence the adjustment and the adjustment path of the vehicle seat to be realized from the starting position into the target position. This for example includes the fact that via the dynamic vehicle-specific restriction parameter an adjustment position of a steering wheel column, a steering wheel support, a central armrest, a center console, a vehicle door, a footrest and/or a vehicle window pane is taken into account and the electronic control device correspondingly is configured to take account of a corresponding adjustment position when actuating the at least one adjustment drive in order to adjust the vehicle seat from the current starting position into the desired target position. This in particular can mean that in dependence on the respective adjustment position the adjustment of the vehicle seat is varied. It can likewise be provided that at least one further adjustment drive is actuated by means of the electronic control device in order to vary an adjustment position of a corresponding adjustable component. In this connection it can be provided for example to change the position of a steering wheel column, a steering wheel support, a central armrest, a center console, a vehicle door (when the vehicle is stationary), a footrest and/or a vehicle window pane in a power-operated way in order to provide for an adjustment of the vehicle seat from the current starting position into the desired target position.

In one design variant it is provided that the characteristic-map data of the characteristic-map memory—possibly in addition to the static and/or dynamic restriction parameters—comprise at least one user-specific restriction parameter which specifies that an adjustment position of at least one adjustable seat component of the vehicle seat remains or will remain unchangeable during the adjustment of the vehicle seat into the target position. The respective adjustment position thus can be blocked here on the part of the user. For example, it can be specified on the part of the user that an adjustable backrest of the vehicle seat remains in a current adjustment position with respect to a seat part and thus is blocked in this adjustment position. For an adjustment of the vehicle seat from the starting position into the target position no adjustment of the backrest hence will be effected. Alternatively or in addition, it can for example be specified on the part of the user that a seat part of the vehicle seat carrying a seat cushion is not changeable in its current adjustment position and correspondingly will remain blocked when the vehicle seat is adjusted into the target position. Via the characteristic-map control, such a user-side constraint correspondingly is taken into account so that the at least one adjustment drive is actuated correspondingly in order satisfy these constraints during the adjustment into the target position.

In particular for the more efficient handling of user-specific restriction parameters the electronic control device can comprise a control logic by means of which it can be checked whether under the corresponding constraint, which is set via the user-specific restriction parameter, the desired target position can actually be reached. If this target position cannot be reached under the given restriction parameters, an information for example can be output to a user, in particular a visual and/or acoustic information, which indicates that the target position cannot be taken with the corresponding default value or with the corresponding default values.

In principle, the adjusting movements specified by the characteristic-map data, which are to be carried out in order to adjust the vehicle seat from the current starting position into the target position, can be dependent on the current starting position of the vehicle seat. Depending on the current starting position (out of several possible starting positions and hence adjustment positions of the vehicle seat and/or its seat components) different adjustment scenarios thus can be specified via the characteristic-map data in order to adjust the vehicle seat into the one target position or into one out of several possible target positions.

The current starting position to be taken into account in particular can include a current adjustment position of at least two seat components of the vehicle seat relative to each other. For example, the characteristic-map data specify different adjusting movements for different adjustment positions of one or more seat components of the vehicle seat, such as for example of a seat part, a backrest and/or a headrest, which are to be carried out by the vehicle seat, seat components adjustably mounted thereon and/or vehicle-side adjustable components not belonging to the vehicle seat within the interior of the vehicle in order to transfer the vehicle seat into the desired target position in a power-operated way.

The at least one adjustment drive of the seat adjuster in principle can be equipped and provided for changing a pivot position of the vehicle seat with respect to the pivot axis and hence for example for a rotation of the vehicle seat by more than 90°. In one design variant, for example, a longitudinal position of the vehicle seat and/or a seat depth on the vehicle seat, an inclination of a seat part and/or a backrest and/or the position of a headrest furthermore is adjustable in a power-operated way by means of the at least one adjustment drive in order to adjust the vehicle seat into the target position. In principle, the same drive motor of the adjustment drive can be used here as well.

Alternatively, at least two adjustment drives are controllable by means of the electronic control device for adjusting the vehicle seat into the target position, by means of which in addition to a pivot position of the vehicle seat with respect to the pivot axis a longitudinal position of the vehicle seat, a seat depth, an inclination of a seat part of the vehicle seat and/or of a backrest of the vehicle seat and/or the position of a headrest of the vehicle seat can be changed in a power-operated way. For example, the electronic control device can be coupled with a power-operated backrest adjuster, power-operated headrest adjuster, power-operated inclination adjuster, power-operated rotary adjuster and/or power-operated longitudinal adjuster of the vehicle seat in order to thereby control an adjustment of the vehicle seat and/or of adjustable seat components provided thereon, so that the vehicle seat is moved from the current starting position into the specified target position.

In particular in one of the design variants explained above it can be provided that via the characteristic-map data—in particular in addition to pivoting of the vehicle seat—adjusting movements to be carried out with and/or on the vehicle seat in a power-operated way are specified in order to adjust the vehicle seat from the current starting position into the target position. This for example includes the fact that via the characteristic-map data a particular order of different adjustment drives to be actuated and/or the duration of an actuation of the respective adjustment drives is specified by the electronic control device. Via the characteristic-map data, for example in dependence on the starting position of the vehicle seat, it can thus be determined via a control logic of the electronic control device what individual adjustment drives must be actuated and how they must be actuated for the adjustment of the vehicle seat and/or for seat components adjustably mounted thereon and/or for the adjustment of adjustable components of the vehicle not belonging to the vehicle seat in order to be able to adjust the vehicle seat from the current starting position into the specified target position. The electronic control device here can be configured to determine from the characteristic-map data and hence from the characteristic map(s) given thereby that adjustment order or adjustment sequence which represents the temporally shortest adjustment from the starting position into the target position. Alternatively, the electronic control device can be configured to determine from the characteristic-map data and hence from the characteristic map(s) given thereby that adjustment order or adjustment sequence which involves the smallest number of adjustments of seat components of the vehicle seat so that the seating position of a seat user during the adjustment of the vehicle seat from the starting position into the target position remains unchanged as far as possible. In a possible development, it can be selected on the electronic control device whether for example the shortest adjustment order or the smallest number of adjustments of seat components of the vehicle seat is decisive as a selection criterion for the determination of the (possible) adjustment order.

To be able to use the seat adjuster with an unchanged vehicle seat in different vehicles and hence to provide for a cross-platform utilization of the seat adjuster with an unchanged vehicle seat, the characteristic-map data of the characteristic-map memory can be rewritable. In this way, different characteristic-map data for different vehicles can be stored in the characteristic-map memory when necessary.

Alternatively or in addition, it can be provided with the same objective that characteristic-map data for different vehicles are selectively stored in the characteristic-map memory.

Before, after or during the installation of the seat adjuster in a particular vehicle, the appropriate characteristic-map data thus can be selected from the characteristic-map memory for example by a fitter.

What is comprised by the proposed solution furthermore is a vehicle with a seat adjuster according to any of the exemplary embodiments explained above.

Another aspect relates to a method for the power-operated adjustment of an adjustable vehicle seat between at least one of possibly several possible starting positions and at least one of possibly several possible target positions in an interior space of a vehicle.

The adjustment of the vehicle seat from the at least one starting position into the at least one target position here can also include at least pivoting of the vehicle seat about a pivot axis which extends along a spatial direction pointing from a vehicle floor of the vehicle to a ceiling of the vehicle when the vehicle seat is properly mounted in the interior of the vehicle. Corresponding to the seat adjuster proposed according to the invention it is furthermore provided that an adjustment of the vehicle seat from a current starting position into a particular target position is effected by means of at least one (motorized) adjustment drive and on the basis of characteristic-map data via which adjusting movements to be carried out by the vehicle seat are specified in order to reach the target position.

One design variant for example provides that the adjusting movements to be carried out by the vehicle seat are dependent on the current starting position and/or at least one vehicle-specific and/or user-specific restriction parameter.

Design variants of a proposed method can be executable by means of a seat adjuster according to the invention. Correspondingly, the features and advantages mentioned above and below for possible exemplary embodiments of a seat adjuster also apply for design variants of a proposed method for adjusting a vehicle seat, and vice versa.

The attached Figures by way of example furthermore illustrate possible design variants of the proposed solution.

In the drawings:

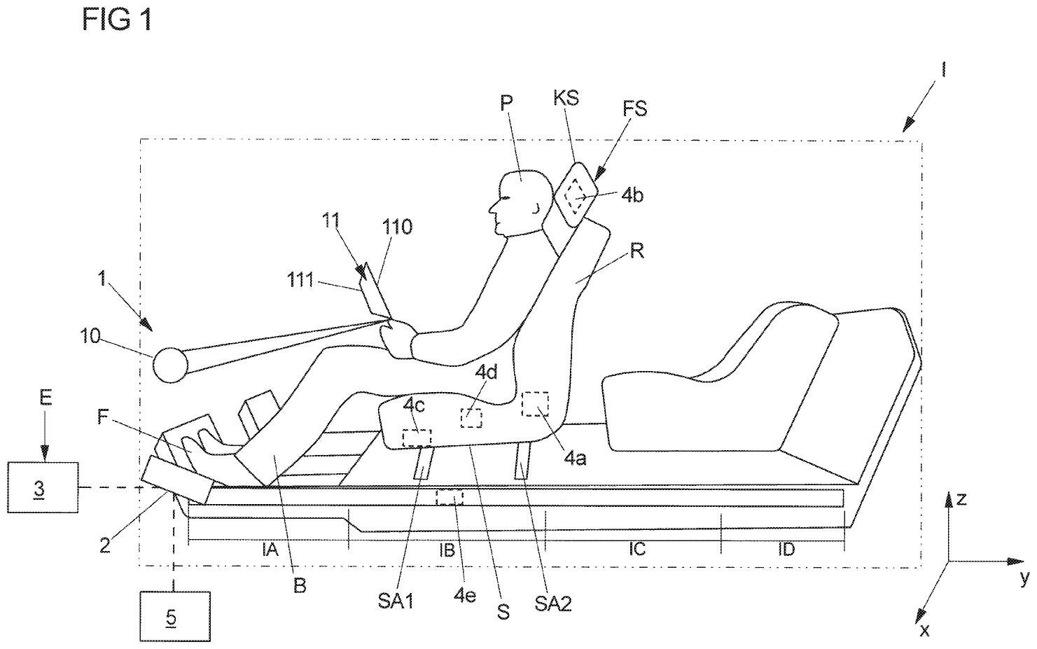

FIG. 1 shows a vehicle interior with an exemplary embodiment of a seat adjuster according to the invention and a vehicle seat of the seat adjuster in a possible starting position;

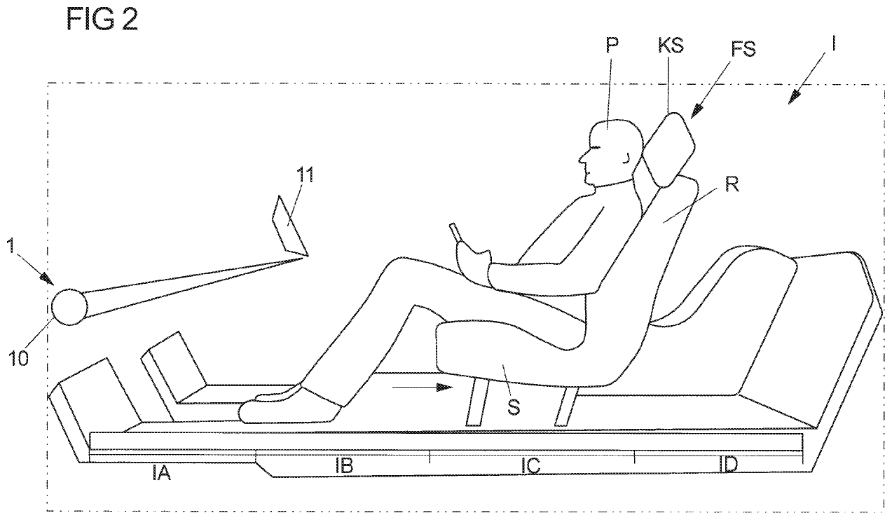

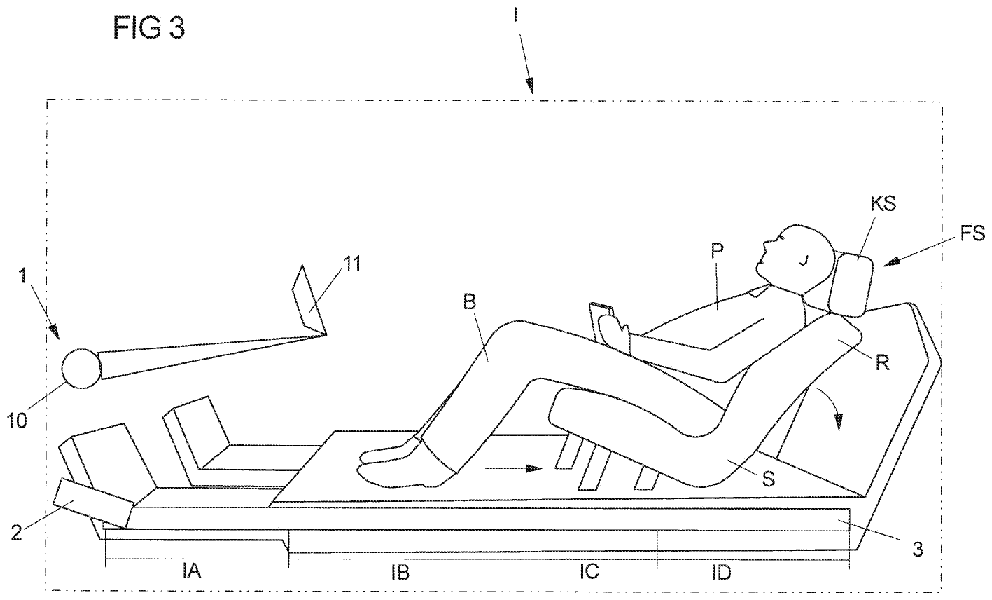

FIGS. 2 and 3 show the vehicle interior with the vehicle seat in two different target positions, which proceeding from the starting position of FIG. 1 can be taken without pivoting the vehicle seat about a vertically extending pivot axis;

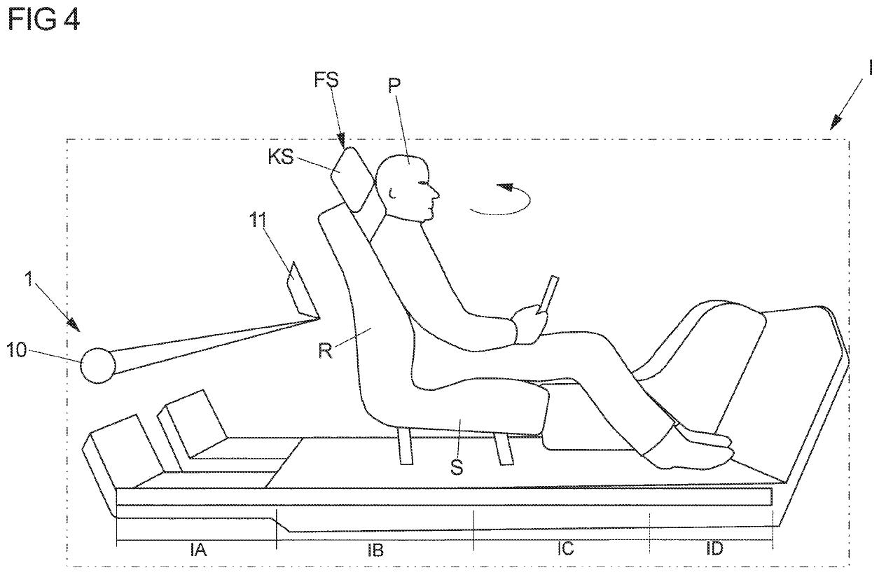

FIG. 4 shows the vehicle interior with the vehicle seat in a target position in which the vehicle seat is rotated by 180° with respect to the starting position of FIG. 1;

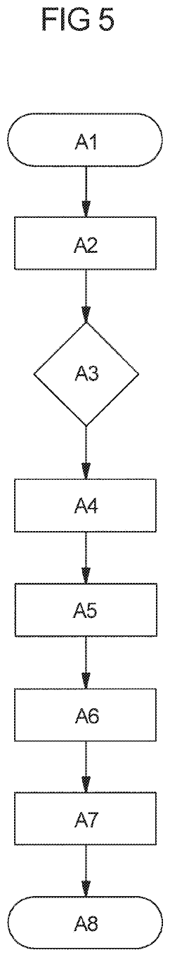

FIG. 5 shows a flow diagram of a design variant for a method for seat adjustment according to the invention.

FIG. 1 shows a vehicle interior I for a vehicle which is able to drive autonomously. In the vehicle interior I a vehicle seat FS is provided. This vehicle seat FS includes a seat part S and a backrest R pivotally arranged thereon in order to support the back of a seat user P. In the seating position of the vehicle seat FS as shown in FIG. 1 the seat part S is disposed in a front interior region IB of the vehicle interior I—based on the vehicle longitudinal direction pointing from the vehicle front to the vehicle rear. In this (front) seating position of the vehicle seat FS, the seat user P can steer the vehicle as a vehicle operator. Correspondingly, he can comfortably grasp a steering wheel provided on a steering wheel support 11 with his hands and actuate a brake pedal with his foot F in order to brake the vehicle when necessary. The foot F and the legs B of the seat user P protrude into a front interior region IA of the vehicle interior I.

Via front and rear rail connections SA1 and SA2, the seat part S of the vehicle seat FS is connected to a rail module which provides for an adjustment of the vehicle seat FA in particular along the longitudinal vehicle axis by means of a motorized adjustment drive in the form of a longitudinal adjuster 4e. The vehicle seat FS here can be longitudinally slidable along almost the entire length of the vehicle interior I and hence along a length of at least 100 cm. Via the longitudinal adjuster 4e, the vehicle seat FS is adjustable in particular from the normal driving position as shown in FIG. 1 for example to the rear into a working position as shown in FIG. 2 in a first rear interior region IC and into a relax position corresponding to FIG. 3 in which the seat part S is inclined backwards and the backrest R pivoted to the rear almost completely protrudes into a rearmost interior region ID of the vehicle interior I.

For a power-operated pivoting of the backrest R with respect to the seat part S about a backrest pivot axis, another motorized adjustment drive can be provided in the form of a backrest adjuster 4a. For the power-operated change of an inclination of the seat part S and/or the seat depth at least one further motorized adjustment drive is provided in the illustrated variant in the form of an inclination adjuster 4c. Furthermore, a headrest KS of the vehicle seat FS also can be adjustable via a motorized adjustment drive in the form of a headrest adjuster 4b. To furthermore adjust the vehicle seat FS into a target position which is pivoted with respect to the starting position of FIG. 1 and to the direction of travel, in particular into a target position rotated by 180° corresponding to FIG. 4, there is furthermore provided a rotary mechanism comprising a motorized adjustment drive in the form of a rotary adjuster 4d on the vehicle seat FS.

The individual adjusters 4a to 4e are coupled with an electronic control device 2. By means of the electronic control device 2, the individual adjusters 4a to 4e are controllable to perform an adjustment of the vehicle seat FS into a desired target position. In the present case, this in particular includes the fact that the seat user P can adjust the vehicle seat FS on the one hand into the working or relax position of FIGS. 2 and 3 and also into the position rotated by 180° as shown in FIG. 4.

In particular, pivoting or rotating the vehicle seat FS about the upright axis extending along a z-direction, in particular depending on the vehicle type and the design of the vehicle interior I, is not easily possible. Here, it can depend in particular on the starting position of the vehicle seat FS and among other things on the relative position of the individual seat components (seat part S, backrest R and headrest KS) whether the desired target position can be taken at all or possibly only by adjustment of one or more of the seat components S, R and KS of the vehicle seat FS. The respective current adjustment position of a seat component S, R, KS influences the starting position of the vehicle seat FS taken as a basis on the part of the electronic control device 2.

Via the electronic control device 2 it is also taken into account whether vehicle components of the vehicle interior I form a potential obstacle in a possible adjustment path to the target position of the vehicle seat FS. Such a vehicle component for example can be a B-pillar of the vehicle. The location of such a vehicle component in the vehicle interior space I, such as for example the location of a B-pillar, here is static and unchangeable.

An adjustability of the vehicle seat FS into the target position furthermore can be influenced by dynamic vehicle-specific constraints. For example, the adjustability of the vehicle seat FS can depend on the position of the steering wheel support 11, the steering column 10 or other adjustable components not belonging to the vehicle seat FS, such as for example a central armrest, a center console, a vehicle door, a footrest or a vehicle window pane. Such adjustable components can represent potential obstacles with which the vehicle seat FS might collide when it is adjusted into the desired target position, without taking account of the respective adjustment position of the corresponding adjustable components. In the present case, the electronic control device 2 for this purpose is not only coupled with the seat-side adjusters 4a to 4b, but also with the steering column 10, the steering wheel support 11 and further component adjusters 5 by means of which a power-operated adjustment of particular adjustable components, for example a center console or an armrest in the vehicle interior I, is made possible.

For an adjustment of the vehicle seat FS from an arbitrary, adjustable starting position into an arbitrary desired target position, in particular into a target position in which the vehicle seat FS is rotated by actuating the rotary adjuster 4d about a substantially vertically extending pivot axis in the vehicle interior I, the electronic control device 2 evaluates the current adjustment position of the individual adjustable components and adjustment drives. Furthermore, the electronic control device 2 can be configured to actuate the steering column 10, the steering wheel support 11 and/or the further component adjusters 5 before or during an adjustment of the vehicle seat FS into the desired target position in order to trigger an adjustment of the respective adjustable component.

The static and dynamic vehicle-specific constraints discussed above including the adjustment positions of the individual adjustable components that do not belong to the vehicle seat FS are included into an evaluation of a control logic of the electronic control device 2 as values for a plurality of restriction parameters in order to determine which adjusters 4a to 4e and 5 or which adjustable components 10, 11 and seat components S, R and KS must be actuated in what way in order to reach the desired target position of the vehicle seat FS. For this purpose, the control logic of the electronic control device 2 employs characteristic-map data of a characteristic-map memory 3 coupled with the electronic control device 2. The characteristic-map memory 3 stores characteristic-map data for adjusting movements to be carried out by the vehicle seat FS in dependence on the respective starting position and the possible vehicle-specific restriction parameters so that by means of these characteristic-map data and by taking account of the individual static and dynamic constraints the electronic control device 2 can determine a (best) possible adjusting sequence at the end of which the vehicle seat FS can be adjusted from the current starting position into the target position which is desired e.g. on the part of the seat user P.

As an additional constraint, the characteristic-map data of the characteristic-map memory 3 or the control logic of the electronic control device 3 for example also can include the fact that one or more of the seat components S, R and KS of the vehicle seat FS must not be adjusted during the adjustment into the desired target position or at best only to a small extent. For example, it can be preset or is to be set by the seat user P that an adjustment position of the backrest R relative to the seat part S, which is set in the current starting position, should remain unchanged. This adjustment position then is blocked so that with reference to the characteristic-map data of the characteristic-map memory 3 the electronic control device 2—if possible—must determine an adjusting sequence and hence an adjustment path in which the target position can be reached without an adjustment of the backrest R and hence without actuating the backrest adjuster 4a. Such preset constraints or constraints to be set on the part of the user are included into the characteristic-map memory 3 or the electronic control device 2 in the form of values for at least one corresponding user-specific restriction parameter by means of a (user) input E.

When a desired or specified target position is not possible under the given constraints and hence with the (static and dynamic) vehicle-specific and user-specific restriction parameters proceeding from the current starting position, a visually and/or acoustically perceptible information is output to the seat user P. The rotatability of the vehicle seat FS corresponding to FIG. 4, so that the seat user P sitting on the vehicle seat looks in the direction of the rear end, for example also can depend on whether the vehicle is driving autonomously and hence a corresponding control signal is applied at the electronic control device 2. After a possible change of the starting position and/or a change of certain constraints on the part of the user, such as for example the cancellation of a blockage of the current adjustment position of a seat component S, R or KS or the change into an autonomous driving mode, an adjustment into the target position can be attempted again.

Via the characteristic-map control provided by means of the characteristic-map memory 3 and the electronic control device 2, a vehicle seat FS can be usable in various vehicles and vehicle types on a cross-platform basis and in principle can identically or at least similarly be adjustable. By specifying vehicle-specific constraints and related restriction parameters merely the characteristic maps for the different vehicle types and model variants then differ from each other. For the respective vehicle type or the respective model variant merely appropriate characteristic-map data must be imported into the characteristic-map memory 3 or be selected. The available adjusting sequences in order to get into a desired target position from different starting positions then ultimately depend on the corresponding restriction parameters for the respective vehicle interior I and the adjustable components present therein and coupled with the electronic control device 2, which do not belong to the vehicle seat FS.

In FIG. 5, the possible sequence for an adjustment of the vehicle seat FS from a current starting position into a desired target position in the vehicle interior I is illustrated by means of a flow diagram.

The method begins at a starting time with a method step A1, at which for example the seat user P triggers the adjustment of the vehicle seat F into a particular target position or such an adjustment is triggered automatically, e.g. because the vehicle changes into an autonomous driving mode. Correspondingly, in one variant it can also be checked in method step A1 whether the vehicle including the vehicle seat FS is driving autonomously and hence an adjustment of the vehicle seat FS into a particular target position is permissible at all.

In a subsequent method step A2 a query can be triggered, in which the seat user P must indicate whether an adjustment of the vehicle seat FS is to be made and, if yes, into what target position (possibly by selection from several possible target positions and hence for example the working position of FIG. 2, the relax position of FIG. 3 or the rotated position of FIG. 4).

Whether in the adjustment to be made a particular seat component S, R or KS is to be blocked in the current adjustment position will be queried in a succeeding method step A3.

After the vehicle-specific and user-specific restriction parameters and their corresponding values hence are set, an electronic query of the currently taken position of the vehicle seat FS and hence of the respective adjustment positions of the individual seat components S, R and KS subsequently is made in a method step A4. For this purpose, for example position encoders of the individual adjustment drives 4a to 4e are queried. In any case, the current (starting) position of the vehicle seat FS, after method step A4 is carried out, is known to the electronic control device 2.

Subsequently (possibly also previously or at the same time) the adjustment positions of the adjustable components within the vehicle interior I, which are likewise coupled with the electronic control device 2 and do not belong to the vehicle seat FS, are determined, such as e.g. the adjustment positions of the steering wheel column 10, the steering wheel support 11 or the adjustable components to be adjusted by the component adjuster(s) 5.

From the available adjustment parameters and restriction parameters a (best) possible adjustment path can be determined by using the characteristic-map data from the characteristic-map memory 3 by means of the control logic of the electronic control device 2 as an adjusting sequence for the actuation of the individual adjustment drives 4a to 4e, 5 and the corresponding seat components S, R and KS as well as the adjustable components 10, 11, on the basis of which the adjustment of the vehicle seat FS into the target position is made in a subsequent method step A7.

After this, the method then is terminated in a method step A8. The electronic control device 2 then for example passes into a sleep mode, until the vehicle seat FS is to be adjusted again.

### LIST OF REFERENCE NUMERALS

1 steering wheel module
10 steering column
11 steering wheel support
2 electronic control device
3 characteristic-map memory
4a backrest adjuster
4b headrest adjuster
4c inclination adjuster
4d rotary adjuster
4e longitudinal adjuster
5 component adjuster
B leg
E (user) input
F foot
FS vehicle seat
I vehicle interior
IA, IB, IC, ID interior region
KS headrest
P seat user
R backrest
S seat part
SA1, SA2 rail connection
SE electronic control device

1. A seat adjuster, which at least comprises
an adjustable vehicle seat (FS) which is adjustable in a power-operated way between at least one starting position and at least one target position in an interior space (I) of a vehicle, wherein the adjustment of the vehicle (FS) seat from the at least one starting position into the at least one target position at least can include pivoting of the vehicle seat (FS) about a pivot axis which extends along a spatial direction (z) pointing from a vehicle floor of the vehicle to a ceiling of the vehicle, and
an electronic control device (2) for controlling at least one adjustment drive (4a-4e) by means of which the vehicle seat can (FS) be driven for a power-operated adjustment from the at least one starting position into the at least one target position,
characterized by
a characteristic-map memory (3) coupled with the electronic control device (2), in which characteristic-map data for adjusting movements to be carried out by the vehicle seat (FS) are stored, wherein the electronic control device (2) controls the at least one adjustment drive (4a-4e) by means of the characteristic-map data in order to adjust the vehicle seat (FS) from a current starting position into a particular target position.

2. The seat adjuster according to claim 1, characterized in that the characteristic-map memory (3) coupled with the electronic control device (2) stores characteristic-map data for adjusting movements to be carried out by the vehicle seat (FS) in dependence on the at least one starting position and at least one vehicle-specific and/or user-specific restriction parameter and the electronic control device (2) controls the at least one adjustment drive (4a-4e) by means of the characteristic-map data in order to adjust the vehicle seat (FS) into the particular target position in dependence on the current starting position.

3. The seat adjuster according to claim 2, characterized in that the characteristic-map data comprise at least one static vehicle-specific restriction parameter which cannot be changed for the vehicle.

4. The seat adjuster according to claim 3, characterized in that the at least one static vehicle-specific restriction parameter is dependent on the dimensions of the interior space (I) of the vehicle and/or on the position and location of immovable vehicle components present in the interior space (I) of the vehicle.

5. The seat adjuster according to claim 4, characterized in that the at least one static vehicle-specific restriction parameter is dependent on the position and location of a headliner, a B-pillar and/or a dashboard of the vehicle.

6. The seat adjuster according to any of the preceding claims 2 to 5, characterized in that the characteristic-map data comprise at least one dynamic vehicle-specific restriction parameter which has at least two values.

7. The seat adjuster according to claim 6, characterized in that the value of the at least one dynamic vehicle-specific restriction parameter is dependent on an adjustment position of at least one adjustable component which does not belong to the vehicle seat.

8. The seat adjuster according to claim 7, characterized in that the at least one adjustable component which does not belong to the vehicle seat comprises a steering wheel column (10), a steering wheel support (11), a central armrest, a center console, a vehicle door, a footrest or a vehicle window pane.

9. The seat adjuster according to any of the preceding claims 2 to 8, characterized in that the characteristic-map data comprise at least one user-specific restriction parameter which specifies that an adjustment position of at least one adjustable seat component (S, R, KS) of the vehicle seat (FS) remains unchangeable during the adjustment of the vehicle seat (FS) into the target position.

10. The seat adjuster according to any of the preceding claims, characterized in that the adjusting movements specified by the characteristic-map data, which are to be carried out in order to adjust the vehicle seat (FS) from the current starting position into the target position, are dependent on the current starting position of the vehicle seat (FS).

11. The seat adjuster according to claim 10, characterized in that the vehicle seat (FS) comprises at least two seat components (S, R, KS) adjustable relative to each other and the current starting position includes a current adjustment position of the at least two seat components (S, R, KS) relative to each other.

12. The seat adjuster according to claim 10 or 11, characterized in that a seat component is a seat part (S), a backrest (R) or a headrest (KS).

13. The seat adjuster according to any of the preceding claims, characterized in that by means of the at least one adjustment drive (4a-4e), in addition to a pivot position of the vehicle seat (FS) with respect to the pivot axis, a longitudinal position of the vehicle seat (FS) and/or on the vehicle seat (FS) a seat depth, an inclination of a seat part (S) and/or a backrest (R) and/or the position of a headrest (KS) can be changed in a power-operated way in order to adjust the vehicle seat (FS) into the target position.

14. The seat adjuster according to any of the preceding claims, characterized in that for the adjustment of the vehicle seat (FS) into the target position by means of the electronic control device (2) at least two adjustment drives (4a-4e) can be controlled, by means of which, in addition to a pivot position of the vehicle seat (FS) with respect to the pivot axis, a longitudinal position of the vehicle seat (FS), a seat depth, an inclination of a seat part (S) and/or a backrest (R) and/or the position of a headrest (KS) can be changed in a power-operated way.

15. The seat adjuster according to any of the preceding claims, characterized in that via the characteristic-map data in addition to pivoting of the vehicle seat (FS) adjusting movements to be carried out in a power-operated way with and/or on the vehicle seat (FS) are specified in order to adjust the vehicle seat (FS) from the current starting position into the target position.

16. The seat adjuster according to any of the preceding claims, characterized in that the characteristic-map data of the characteristic-map memory (3) are rewritable for utilizing the seat adjuster in different vehicles with an unchanged vehicle seat (FS).

17. The seat adjuster according to any of the preceding claims, characterized in that the characteristic-map memory (3) selectively stores characteristic-map data for different vehicles.

18. A vehicle with a seat adjuster according to any of claims 1 to 17.

19. A method for the power-operated adjustment of an adjustable vehicle seat (FS) between at least one starting position and at least one target position in an interior space (I) of a vehicle, wherein the adjustment of the vehicle seat (FS) from the at least one starting position into the at least one target position at least can include pivoting of the vehicle seat (FS) about a pivot axis which extends along a spatial direction (z) pointing from a vehicle floor of the vehicle to a ceiling of the vehicle,
characterized in that
an adjustment of the vehicle seat (FS) from a current starting position into a particular target position is effected by means of at least one adjustment drive (4a-4e) and on the basis of characteristic-map data via which adjusting movements to be carried out by the vehicle seat (FS) are specified in order to reach the target position.

20. The method according to claim 19, characterized in that the adjusting movements to be carried out by the vehicle seat (FS) are dependent on the current starting position and/or at least one vehicle-specific and/or user-specific restriction parameter.
